(19) United States
(12) Patent Application Publication
(10) Pub. No.: US 2025/0286394 A1
(43) Pub. Date: Sep. 11, 2025

(54) Portable Charging Device With Infrared Function

(71) Applicant: Shenzhen DeOne Innovation Technology Co.,ltd, Shenzhen (CN)

(72) Inventor: Jiongjun Cai, Shenzhen (CN)

(21) Appl. No.: 18/677,872

(22) Filed: May 30, 2024

(30) Foreign Application Priority Data
Mar. 5, 2024 (CN) 202420420243X

(51) Int. Cl. H02J 7/00; G06F 1/16

(52) U.S. Cl. CPC H02J 7/0042; G06F 1/163

(57) ABSTRACT

A portable charging device with infrared function includes a housing. An infrared emitter is provided on the housing, the infrared emitter is used to emit infrared rays to an area or an object to be observed, and at this time an external electronic device receives the infrared rays emitted or reflected from the area or the object to be observed. A power supply unit is provided in the housing, the power supply unit is used to supply power to an electronic component in the portable charging device, and the power supply unit is also used for charging the external electronic device. The portable charging device can achieve the virtual reality helmet or game glasses operates for a long time, and also has advantages of normal use in a case of insufficient infrared light.

### TECHNICAL FIELD

The present application relates to the technical field of charging devices, and in particular to a portable charging device with infrared function.

### BACKGROUND

Infrared imaging is a technique to obtain a visible plane image of a scene by means of infrared radiation, its basic principle is that a difference (or distribution state) of infrared energy reflected or radiated by the scene or different parts of the scene is recorded, and then converted it into two-dimensional visible images in a certain way.

Currently, infrared imaging technology is adopted in some virtual reality helmet or game glasses. Although this technology may enrich a user's experience, it is difficult to work for a long time due to high power consumption and working temperature. Moreover, this technology is used in a case of insufficient infrared light, which will result in inaccurate positioning of a device, position drift, and frequent alarms/errors.

### SUMMARY

In view of defects and deficiencies in existing technologies, the present disclosure aims to provide a portable charging device with infrared function, which has advantage of being capable of charging an electronic device, and also being capable of emitting infrared rays for supplementary lighting.

To achieve above objectives, the present disclosure adopts following technical solutions. In some embodiments of the present disclosure, a portable charging device with infrared function, including a housing. Herein an infrared emitter is provided on the housing, the infrared emitter is used to emit infrared rays to an area or an object to be observed, and at this time an external electronic device receives the infrared rays emitted or reflected from the area or the object to be observed. Moreover, a power supply unit is provided in the housing, the power supply unit is used to supply power to an electronic component in the portable charging device, and the power supply unit is also used for charging the external electronic device.

Preferably, the external electronic device is a helmet, the helmet is provided with an infrared receiver and a display, the infrared receiver is used to receive the infrared rays emitted or reflected from the area or object to be observed, the helmet is used to convert the infrared rays into image information, and the display is used to display the image information.

Preferably, the helmet is connected to the power supply unit by means of a data cable.

Preferably, the housing comprises a first housing, and a second and a third housings assembled on both sides of the first housing, and the first housing, and the second and the third housings after assembled are configured in a penannular shape.

Preferably, the second and the third housings each is provided with an upper housing and a lower housing, a cavity is formed between the upper housing and the lower housing, and the power supply unit is placed in the cavity.

Preferably, a control circuit board is provided in the cavity, the control circuit board is coupled to the power supply unit, and the infrared emitter is also coupled to the control circuit board.

Preferably, the control circuit board is coupled with a push switch and the push switch is pressed by a user to control on or off of the infrared emitter.

Preferably, the control circuit board is coupled with a power light.

Preferably, the upper housing and the lower housing are provided with clamping frames on one side close to the first housing, and the first housing is correspondingly provided with clamping joints snap into the clamping frames.

Preferably, the housing is provided with a charging and discharging section coupled to the control circuit board, and the charging and the discharging section comprises a charging interface and a discharging interface.

With adoption of above technical solutions, the portable charging device with infrared function of the present disclosure has at least following beneficial effects and advantages. By setting the infrared emitter on the housing, the infrared emitter can emit infrared rays for the area or the object to be observed, so that the external electronic device can receive the infrared rays emitted or reflected from the area or the object to be observed, and the external electronic device processes the infrared rays emitted or reflected and then converts the infrared rays into image information. Moreover, by setting the power supply unit in the housing, the power supply unit can supply power to the external electronic device, and also can supply power to the infrared emitter. Thus the portable charging device with infrared function of the present disclosure can solve the defects that existing virtual reality helmet or game glasses are difficult to operate for a long time as well as inconvenience of using them in a case of insufficient infrared light, so that the virtual reality helmet or game glasses can operate for a long time, and also has advantages of normal use in the case of insufficient infrared light.

### BRIEF DESCRIPTION OF THE DRAWINGS

In order to more clearly illustrate the technical solutions in the embodiments of the present disclosure or in the existing technologies, accompanying drawings to be used in the description of the embodiments or the existing technologies will be briefly introduced below. It will be obvious that the accompanying drawings in the following description are only some of the embodiments of the present disclosure, and for a person of ordinary skill in the art, other drawings can be obtained based on these accompanying drawings without paying creative labor.

FIG. 1 shows a structural schematic diagram of a portable charging device with infrared function in accordance with some embodiments of the present disclosure.

FIG. 2 shows an exploded view of FIG. 1.

FIG. 3 shows a schematic diagram of a usage state of FIG. 1.

In the drawings, reference signs are as follows. 1. First housing, 11. Connecting piece, 111. Clamping joint, 112. Stud, 113. Clamping frame, 12. Second housing, 121. Upper housing, 122. Lower housing, 13. Third housing, 14. Charging and discharging section, 141. Charging interface, 142. Discharging interface, 15. Power light, 16. Push switch, 17. Infrared emitter, 18. Power supply unit, 19. Control circuit board, 2. External electronic device, 21. Infrared receiver, 3. Data cable.

### DETAILED DESCRIPTION OF THE EMBODIMENTS

The present disclosure will be described in further detail below in conjunction with the accompanying drawings.

These specific embodiments are only explanations of the present disclosure, which are not a limitation of the present disclosure. And for the person of ordinary skill in the art, after reading this specification, any modification to these embodiments as needed without creative contribution, shall fall within the scope of protection of the appending claims of the present invention.

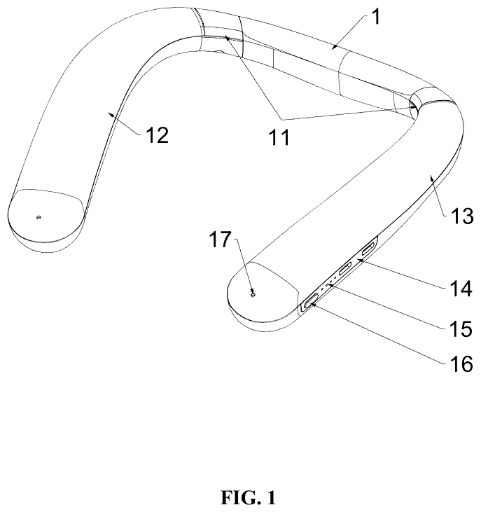

In some embodiments of the present disclosure, a portable charging device with infrared function is provided, as shown in FIG. 1, the portable charging device includes a housing, a power supply unit 18 is provided in the housing, the power supply unit 18 is used to supply power to other electronic components in the portable charging device, and the power supply unit 18 is also used for charging an external electronic device 2. Moreover, an infrared emitter 17 is also provided on the housing, the infrared emitter 17 is used to emit infrared rays to an area or an object to be observed. And at this time, infrared rays emitted or reflected from the area or the object to be observed enters into the infrared receiver 21 of the external electronic device 2, and after the external electronic device 2 receives the infrared rays, it can convert the infrared rays into image information. A display is provided on the external electronic device 2, and the image information is displayed on the display after being processed by the external electronic device 2.

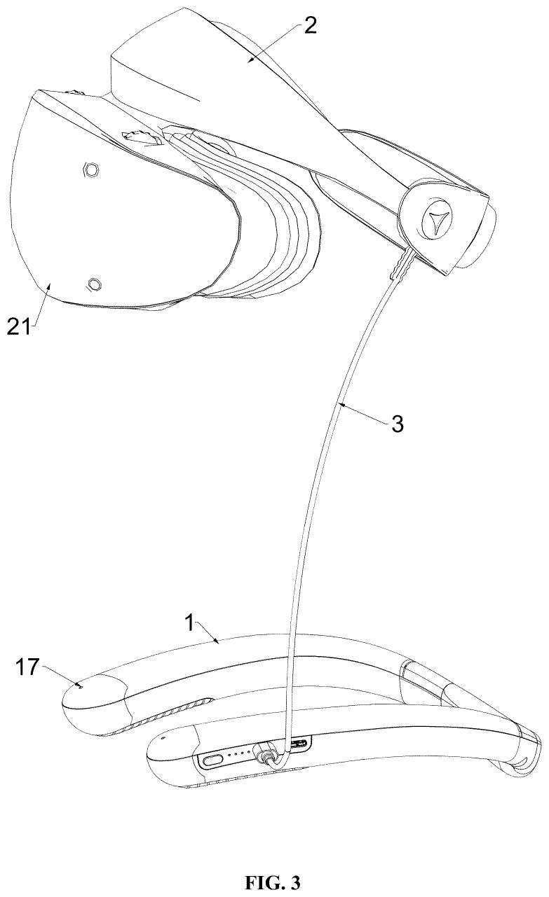

Preferably, as shown in FIG. 3, the external electronic device 2 may be a helmet or game glasses, or a cell phone, but it needs to have the infrared receiver 21. Specifically, the external electronic device 2 of the embodiments is the helmet, and the helmet is provided with the display and the infrared receiver 21 at a front part thereon. When a user puts on the helmet, the helmet is directed toward the infrared emitter 17 to irradiate the area or the object to be observed to obtain reflected infrared rays, the helmet is used to convert the infrared rays into the image information, and the display is used to display the image information, then the user can observe the image information displayed on the display through the helmet to enrich the user's experience.

In the embodiments, the portable charging device is intended to be worn around a neck of the user to facilitate the infrared emitter 17 can follow actions of human body in transmitting the infrared rays, and also to facilitate the helmet can be used and charged at the same time. In other embodiments, the portable charging device may be detachably assembled on the helmet, or may be a base placed on ground or a desktop.

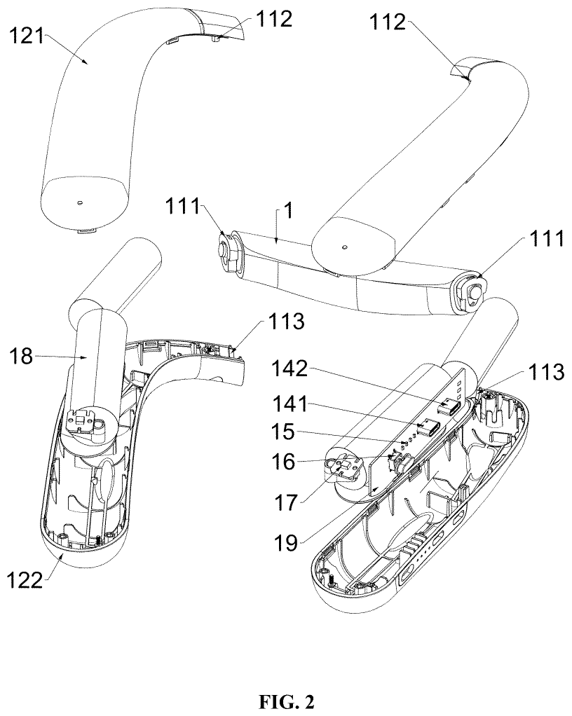

Preferably, as shown in FIG. 2, the housing includes a first housing 1, and a second housing 12 and a third housing 13 assembled on both sides of the first housing 1. Herein the first housing 1, the second housing 12 and the third housing 13 are provided in a form of a strip, a connection between the first housing 1 and the second housing 12 is provided in a form of an arc, and a connection between the first housing 1 and the third housing 13 is also provided in the form of the arc. The first housing 1, the second housing 12 and the third housing 13 after assembled are configured in a penannular shape, and the first housing 1, the second housing 12 and the third housing 13 after assembled are adapted to fit the neck of the user.

It should be noted that the second housing 12 and the third housing 13 each is provided with an upper housing 121 and a lower housing 122. The upper housing 121 and the lower housing 122 are provided with a stud 112 and a screw hole respectively, the upper housing 121 and the lower housing 122 can be fixedly assembled by means of threading a screw through the stud 112 and the screw hole. A cavity is formed between the upper housing 121 and the lower housing 122, and the power supply unit 18 is placed in the cavity. The power supply unit 18 is preferably rechargeable lithium batteries and has a cylindrical or block shape. The rechargeable lithium batteries may be set more than one, for example, the rechargeable lithium batteries in the embodiments are set to have four, two rechargeable lithium batteries are provided in the second housing 12 and the third housing 13 respectively, to share a weight of the rechargeable lithium batteries. A wire is provided to pass through the first housing 1, through which the second housing 12 can be electrically connected to the rechargeable lithium batteries in the third housing 13.

In the embodiments, the upper housing 121 and the lower housing 122 are provided with clamping frames 113 on one side close to the first housing 1, and the first housing 1 is correspondingly provided with clamping joints 111 snap into the clamping frames 113, to achieve a snap-fit assembly of the second housing 12 with the first housing 1, and a snap-fit assembly of the third housing 3 with the first housing 1.

Preferably, a control circuit board 19 is provided in the cavity, specifically, the control circuit board 19 is provided in the third housing 13. In other embodiments, the control circuit board 19 is provided in the second housing 12 or in the first housing 1, or may be provided in two or three of the first housing 1, the second housing 12 and the third housing 13. The control circuit board 19 is coupled to the power supply unit 18, and the infrared emitter 17 is also coupled to the control circuit board 19.

It is to be added that, the control circuit board 19 is coupled with a push switch 16, and a hole is provided on the third housing 13 for exposing the push switch 16, which is convenient for the user to press. The push switch 16 can turn on the infrared emitter 17 when the user short presses it, and can turn off the infrared emitter 17 when the user long presses it. In one example, the push switch 16 is used to turn on or off the entire portable charging device.

Preferably, there is a power light 15 coupled to the control circuit board 19, which can display a remaining power of the power supply unit 18, and also can display whether the power supply unit 18 is in a charging state. The power light 15 may be provided with a plurality and arranged in line, such as in this embodiments, the power light 15 is provided with three. When three power lights 15 are always lit, it means that an electric quantity of the power supply unit 18 is greater than 70%. When two power lights 15 are always lit, it means that the electric quantity of the power supply unit 18 is greater than 40%. When one power light 15 is always lit, it means that the electric quantity of the power supply unit 18 is greater than 10%. When three power lights 15 are blinking at the same time, it means that the electric quantity of the power supply unit 18 is less than 10%. And when one power light 15 is blinking, it also means that the electric quantity of the power supply unit 18 is less than 10%.

Preferably, there is a charging and discharging section 14 coupled with the control circuit board 19 on the housing, the charging and the discharging section 14 includes a charging interface 141 and a discharging interface 142, the discharging interface 142 can charge the external electronic device 2. Although the external electronic device 2 in the embodiments is provided with the infrared emitter 17, in other embodiments it may also possible to charge other devices that do not have the infrared emitter 17, such as charging a Bluetooth headset or a tablet. Herein the charging interface 141 is used for an external power source to charge the power supply unit 18 in the housing. It should be noted that the helmet and the discharging interface 142 realize the current transfer through a data cable 3. In the embodiments, the charging interface 141 and the discharging interface 142 are both USB-C interfaces.

The forgoing description is only to illustrate the technical solutions of the present disclosure rather than limitations, any modifications or equivalent replacement made by the person ordinary skill in the art, as long as not out of the concept and the scope of the technical solutions of the present disclosure, shall be covered by the scope of appending claims of the present invention.

What is claimed is:

1. A portable charging device with infrared function, comprising a housing;
wherein an infrared emitter is provided on the housing, the infrared emitter is used to emit infrared rays to an area or an object to be observed, and at this time an external electronic device receives the infrared rays emitted or reflected from the area or the object to be observed; and
wherein a power supply unit is provided in the housing, the power supply unit is used to supply power to an electronic component in the portable charging device, and the power supply unit is also used for charging the external electronic device.

2. The portable charging device with infrared function according to claim 1, wherein the external electronic device is a helmet, the helmet is provided with an infrared receiver and a display, the infrared receiver is used to receive the infrared rays emitted or reflected from the area or object to be observed, the helmet is used to convert the infrared rays into image information, and the display is used to display the image information.

3. The portable charging device with infrared function according to claim 2, wherein the helmet is connected to the power supply unit by means of a data cable.

4. The portable charging device with infrared function according to claim 1, wherein the housing comprises a first housing, and a second and a third housings assembled on both sides of the first housing, and the first housing, and the second and the third housings after assembled are configured in a penannular shape.

5. The portable charging device with infrared function according to claim 4, wherein the second and the third housings each is provided with an upper housing and a lower housing, a cavity is formed between the upper housing and the lower housing, and the power supply unit is placed in the cavity.

6. The portable charging device with infrared function according to claim 5, wherein a control circuit board is provided in the cavity, the control circuit board is coupled to the power supply unit, and the infrared emitter is also coupled to the control circuit board.

7. The portable charging device with infrared function according to claim 6, wherein the control circuit board is coupled with a push switch and the push switch is pressed by a user to control on or off of the infrared emitter.

8. The portable charging device with infrared function according to claim 6, wherein the control circuit board is coupled with a power light.

9. The portable charging device with infrared function according to claim 5, wherein the upper housing and the lower housing are provided with clamping frames on one side close to the first housing, and the first housing is correspondingly provided with clamping joints snap into the clamping frames.

10. The portable charging device with infrared function according to claim 6, wherein the housing is provided with a charging and discharging section coupled with the control circuit board, and the charging and the discharging section comprises a charging interface and a discharging interface.
